(19) United States
(12) Patent Application Publication
(10) Pub. No.: US 2008/0116720 A1
(43) Pub. Date: May 22, 2008

(54) VEHICLE

(76) Inventors: Takashi Yamaguchi, Hitachinaka-shi (JP); Toshiharu Miyamoto, Kudamatsu-shi (JP); Toshihiko Mochida, Shunan-shi (JP); Takeshi Kawasaki, Kudamatsu-shi (JP); Hideyuki Nakamura, Kudamatsu-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/943,113

(22) Filed: Nov. 20, 2007

(30) Foreign Application Priority Data
Nov. 21, 2006 (JP) 2006-314594

(51) Int. Cl. B60R 21/04

(52) U.S. Cl. 296/187.11

(57) ABSTRACT

There is provided a vehicle equipped with a shock absorbing structure that can absorb collision energy stably under all collision conditions to ensure the safety of crew members and passengers. The shock absorbing structure is arranged in an end part of the vehicle. The shock absorbing structure comprises an upper-stage shock absorbing structure 100 that is arranged in an upper part of a crushable zone to absorb collision energy by being crushed by a predetermined load, a lower-stage shock absorbing structure 120 that is arranged in a lower part of the crushable zone to absorb the collision energy by being crushed by the predetermined load, and a middle-stage shock absorbing structure 110 that is held between the upper-stage shock absorbing structure 100 and the lower-stage shock absorbing structure 120 arranged over and under the middle-stage shock absorbing structure 110. The middle-stage shock absorbing structure 110 includes a buffer structure 112 and a slide structure 113, and the buffer structure 112 is slid to the rear by the predetermined load.

The present application is based on and claims priority of Japanese patent application No. 2006-314594 filed on Nov. 21, 2006, the entire contents of which are hereby incorporated by reference.

### BACKGROUND OF THE INVENTION

1. Field of the Invention

The present invention relates to a vehicle equipped with a shock absorbing structure functioning at the time of collision in transportation equipment typified by a railroad vehicle, a road vehicle, and the like.

2. Description of the Related Art

For the transportation equipment typified by a railroad vehicle, a road vehicle, and the like, an unexpected collision may occur during running. Therefore, there is around an idea that energy is absorbed by positively deforming a part of transportation equipment to protect crew members and passengers on board the transportation equipment. This idea is that a space that is uncrushed at the time of collision to protect the crew members and passengers on board (hereinafter referred to as a survival zone) and a space that absorbs energy by positively deforming a structure at the time of collision (hereinafter referred to as a crushable zone) are provided separately. In this idea, a principal structure constituting the crushable zone is referred to as a shock absorbing structure.

In the case of a railroad vehicle running on a railroad track, the main collision position is an end part of each vehicle, so that the shock absorbing structure is arranged in the end part of the vehicle.

Japanese Patent Laid-Open Publication No. 2005-350065 discloses an example of shock absorbing structure in which an energy absorbing block formed by a hollow extrusion is arranged at a lower part of the end part of the vehicle to efficiently absorb collision energy.

A problem with the above-described related art is that although a sufficient effect can be achieved against the collision at a position at which the energy absorbing block is arranged, collision energy cannot be absorbed stably under other collision conditions. As the collision conditions of railroad vehicle, (1) a railroad vehicle on the same railroad track, (2) a small obstacle such as a stone and a small animal on the railroad track, and (3) a large obstacle such as a vehicle stopping in a railroad crossing can be cited. In the collision with another railroad vehicle of item (1), collision energy can be absorbed by the energy absorbing block arranged at the tip end of vehicle because the collision occurs at the tip end of vehicle. However, in some cases, different types of vehicles run on the same railroad track. In this case, vehicles having shock absorbing structures of a different construction collide with each other, so that an offset collision in which the collision positions of energy absorbing blocks shift from each other occurs. In the offset collision, a load is applied unbalancedly to the energy absorbing block, so that the energy absorbing block is curved while being not crushed sufficiently in the travel direction, disabling sufficient absorption of energy. Therefore, the shock absorbing structure must be designed so as to be capable of absorbing energy sufficiently even in the offset collision. Also, in the offset collision, a phenomenon that one railroad vehicle runs onto the other railroad vehicle (an overriding collision) may occur, so that this overriding collision must also be considered. The small obstacle of item (2) is removed by an obstacle deflector attached to the first car. The large obstacle of item (3) collides with the whole surface of the end part of railroad vehicle. The position and timing of a load applied to the end part of railroad vehicle depend on the shape and crushing manner of obstacle. Therefore, the shock absorbing structure must be constructed assuming all collision patterns. Also, as in the case of the collision between railroad vehicles, the obstacle may run onto the window or roof of the driver's cab, so that the overriding collision must be considered. Especially in the case of a high-speed vehicle, the overriding collision occurs easily because the tip end of vehicle has a streamline shape.

In order to meet all of these collision conditions, a construction in which the energy absorbing blocks are arranged at all collision positions is thought of. However, in the case where the plurality of energy absorbing blocks are crushed in association, there occur phenomena that a shock force at the time of collision is too strong, so that the crew members and passengers are injured, and that the survival zone, not the energy absorbing block, is crushed first. Therefore, in the design of shock absorbing structure, it is necessary to properly set the crush load and arrangement position of the energy absorbing block.

### SUMMARY OF THE INVENTION

The present invention has been made in view of the above circumstances, and accordingly an object thereof is to provide a vehicle equipped with a shock absorbing structure that can absorb collision energy stably under all collision conditions to ensure the safety of crew members and passengers.

To achieve the above object, the present invention provides a vehicle in which a shock absorbing structure is arranged in an end part of the vehicle, the shock absorbing structure including an upper-stage shock absorbing means which is arranged in an upper part of a crushable zone to absorb collision energy by being crushed by a predetermined load; a lower-stage shock absorbing means which is arranged in a lower part of the crushable zone to absorb the collision energy by being crushed by the predetermined load; and a middle-stage shock absorbing means which is held between the upper-stage shock absorbing means and the lower-stage shock absorbing means arranged over and under the middle-stage shock absorbing means, wherein the middle-stage shock absorbing means includes a buffer means and a slide means, and the buffer means is slid to the rear by the predetermined load.

Also, a run-on preventing means that extends in the travel direction outside the end of the lower-stage shock absorbing means to provide a level difference is provided in a boundary part between the middle-stage shock absorbing means and the lower-stage shock absorbing means. Thereby, an overriding collision can be prevented.

Further, spaces wider than crush wrinkles of the upper and lower-stage shock absorbing means are secured between the middle-stage shock absorbing means and the upper-stage shock absorbing means and between the middle-stage shock absorbing means and the lower-stage shock absorbing means, and the buffer means having a length not longer than the crush remaining amount of the upper and lower-stage shock absorbing means is provided. Thereby, stable energy absorption can be realized.

According to the present invention, there can be provided a vehicle equipped with the shock absorbing structure that can absorb collision energy stably under all collision conditions to ensure the safety of crew members and passengers.

### BRIEF DESCRIPTION OF THE DRAWINGS

FIG. 1 is an explanatory view showing a general configuration example of a shock absorbing structure in accordance with one embodiment of the present invention;

FIG. 2 is a side view showing a configuration example of a shock absorbing structure in accordance with one embodiment of the present invention;

FIG. 3 is a side view of a shock absorbing structure, showing a state in which an energy absorbing block in accordance with one embodiment of the present invention has been crushed completely;

FIG. 4 is a side view showing a configuration example of a shock absorbing structure in accordance with one embodiment of the present invention;

FIG. 5 is a perspective view showing a configuration example of a general railroad vehicle body structure;

FIG. 6 is a side view of an end part of a railroad vehicle equipped with a conventional shock absorbing structure;

FIG. 7 is a front view of an end part of a railroad vehicle equipped with a conventional shock absorbing structure; and

FIG. 8 is a plan view of an end part of a railroad vehicle equipped with a conventional shock absorbing structure.

### DETAILED DESCRIPTION OF THE PREFERRED EMBODIMENTS

One embodiment of the present invention will now be described with reference to the accompanying drawings. First, a general railroad vehicle body structure and shock absorbing structure are explained with reference to FIGS. 5 to 8.

FIG. 5 is a perspective view showing a configuration example of the general railroad vehicle body structure. In FIG. 5, a railroad vehicle body structure 1 is made up of a roof body structure 2 forming a roof, end body structures 3 forming end surfaces that close both ends in the longitudinal direction of a vehicle body, side body structures 4 forming right and left side surfaces with respect to the longitudinal direction of the vehicle body, and an underframe 5 forming a floor surface. In the lowermost part of the side body structure 4 and at each end of the underframe 5, a side beam 6, which is one of the members forming the underframe 5, is provided. Also, the end body structures 3 and the side body structures 4 have openings such as windows and doorways.

The railroad vehicle body structure 1 having a basic construction as described above includes a survival zone 10 that protects the lives of crew members and passengers at the time of collision and crushable zones 11a and 11b that absorb energy generated at the time of collision. The survival zone 10 is provided in the center in the longitudinal direction of the vehicle. The crushable zones 11a and 11b are provided in both end parts in the longitudinal direction of the vehicle, and are arranged as if they hold the survival zone 10 therebetween.

In FIG. 5, the configuration has been explained by using a vehicle having no driver's cab. In the vehicle having the driver's cab as well, the basic configuration and the relative arrangement of the crushable zones 11a and 11b and the survival zone 10 are the same.

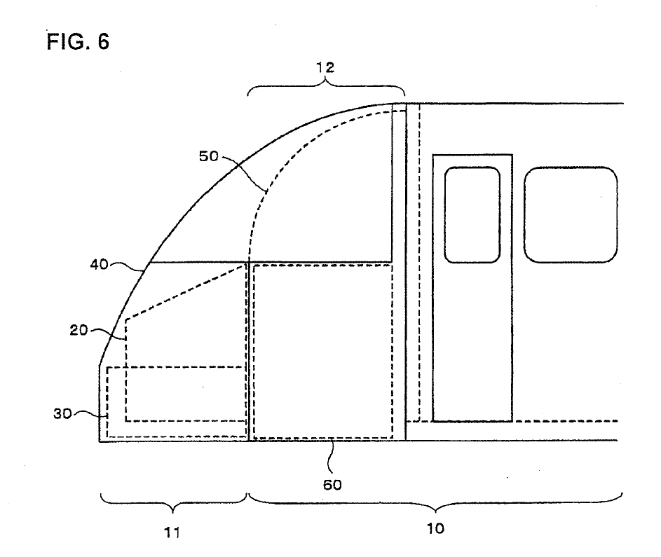

Next, the general shock absorbing structure is explained. FIG. 6 is a side view of the end part of a railroad vehicle equipped with the shock absorbing structure. Referring to FIG. 6, a configuration example of a general crushable zone is explained.

In FIG. 6, the crushable zone 11 includes a shock absorbing structure 20, a coupler 30, and an outside sheet 40. Each of the components of the crushable zone 11 has a strength and construction that can withstand shocks and vibrations caused by the usual operation. That is to say, the component is constructed so as to be capable of sufficiently withstanding the masses of the driver and devices and the vibrations acting during usual operation. Also, the outside shell 40 is provided to improve the appearance and to control wind pressure during running, so that it scarcely exerts an influence on the behavior at the time of collision. FIG. 6 shows an example of a vehicle which has a driver's cab and the end part of which has a streamline shape. The driver's cab 50 belongs to the survival zone 10. On the other hand, in the case where the end part of vehicle has a flat surface, a driver's cab region 12 also belongs to the crushable zone 11. The shock absorbing structure in this case is arranged in a shock absorbing structure region 60 under the driver's cab 50.

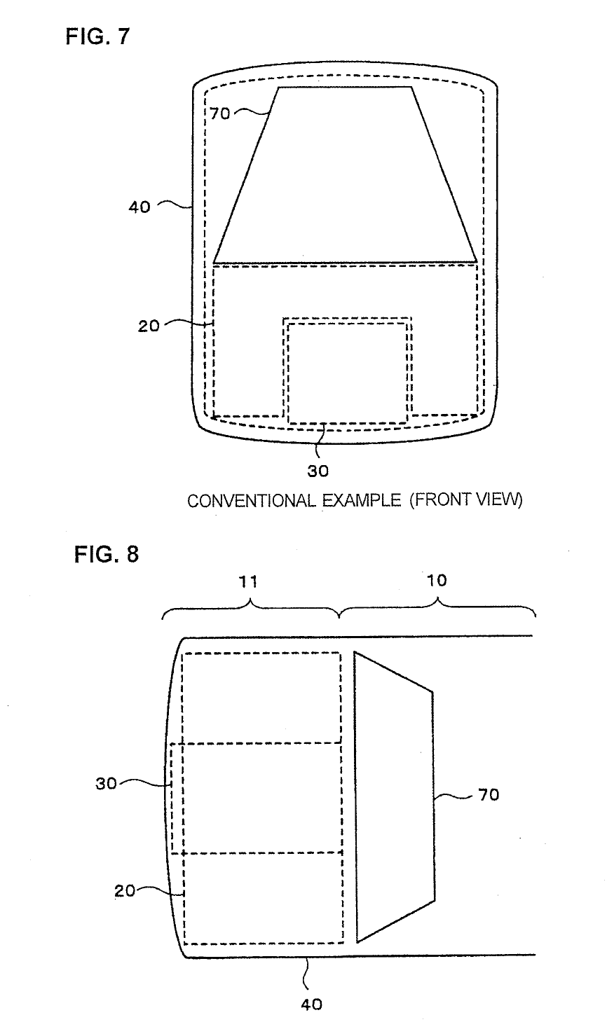

FIG. 7 is a front view of the end part of the railroad vehicle equipped with the shock absorbing structure shown in FIG. 6. In FIG. 7, most of the whole of the vehicle is covered by the outside shell 40, and a window 70 is partially provided. In the crushable zone 11, in the interior covered by the outside shell 40, the shock absorbing structure 20 and the coupler 30 are present. The shock absorbing structure 20 is arranged in a region in which the shock absorbing structure 20 does not interfere with the coupler 30.

FIG. 8 is a plan view of the end part of the railroad vehicle equipped with the shock absorbing structure shown in FIG. 6. In FIG. 8, the whole of the vehicle is covered by the outside shell 40, and a window 70 is partially provided. In the crushable zone 11, in the interior covered by the outside shell 40, the shock absorbing structure 20 and the coupler 30 are present.

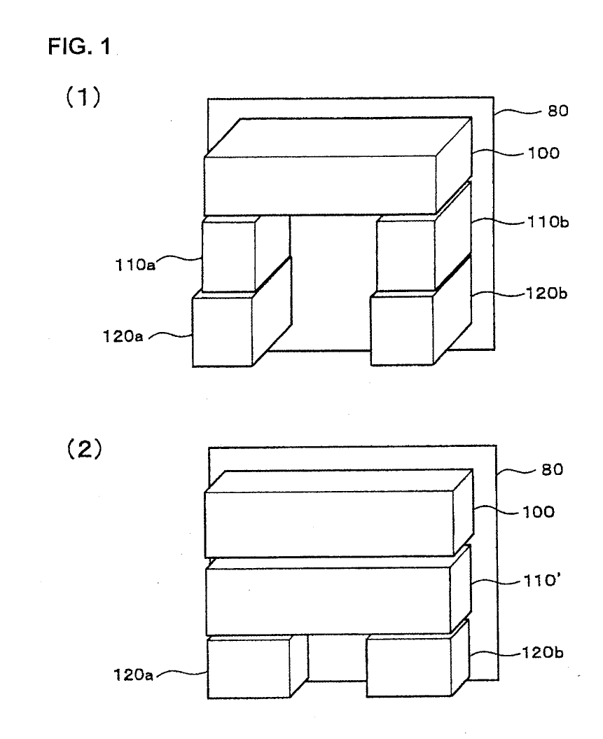

Next, one embodiment of the present invention is explained with reference to FIGS. 1 to 4. FIG. 1 is a configuration view showing a general configuration example of the shock absorbing structure of this example.

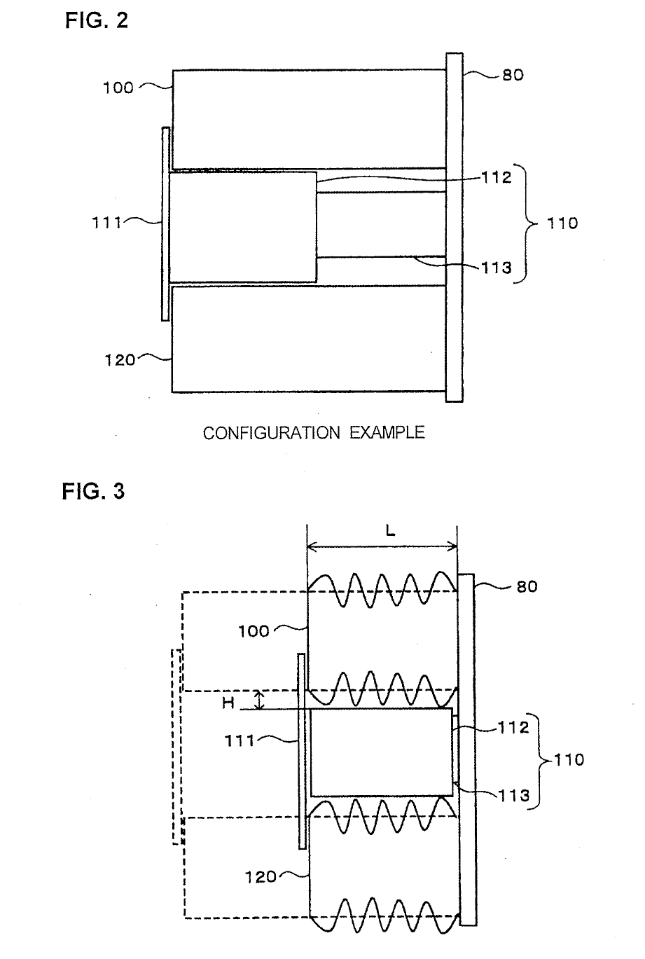

In the configuration example shown in FIG. 1(1), the shock absorbing structure comprises an upper-stage shock absorbing structure 100, which is an upper-stage shock absorbing means, middle-stage shock absorbing structures 110a and 110b, which are middle-stage shock absorbing means, and lower-stage shock absorbing structures 120a and 120b, which are lower-stage shock absorbing means. In FIG. 1(1), the middle-stage shock absorbing structures 110a and 110b and the lower-stage shock absorbing structures 120a and 120b are arranged so as to be divided into the right and left to ensure a region in which the coupler is arranged. These shock absorbing structures are fixed to a wall 80 that divides the vehicle body structure into the survival zone 10 and the crushable zone 11. The lower-stage shock absorbing structures 120a and 120b, which are parts that collide with an obstacle first, absorb most of collision energy by means of energy absorbing blocks arranged therein. The upper-stage shock absorbing structure 100 is arranged to cope with a collision with a large obstacle or running of the large obstacle onto the driver's cab, and pushes back the obstacle while adequately absorbing the collision energy. The middle-stage shock absorbing structures 110a and 110b cope with a collision with a large obstacle, prevent the upper and lower-stage shock absorbing structures from shifting from the colliding object, prevent the upper and lower-stage shock absorbing structures from falling, and carry out control so that these shock absorbing structures crush in the travel direction stably. The specific configuration and operation of the middle-stage shock absorbing structures are explained later with reference to FIGS. 2 and 3.

FIG. 1(2) shows another configuration example of the shock absorbing structure of this example. FIG. 1(2) shows an example in which the coupler is accommodated within the height of the lower-stage shock absorbing structures. In FIG. 1(1), the middle-stage shock absorbing structures are arranged so as to be divided into the right and left considering the region for the coupler. In FIG. 1(2), however, a middle-stage shock absorbing structure 110′ is arranged without being divided. Thus, the arrangement and the specific shape of the shock absorbing structure can be configured according to the construction of vehicle to which the shock absorbing structure is applied.

FIG. 2 is a side view of the shock absorbing structure, the view being used to explain the case where a large obstacle collides with a vehicle having the shock absorbing structure of this example.

In FIG. 2, a middle-stage shock absorbing structure 110 comprises a buffer structure 112, which is a buffer means, and a slide structure 113, which is a slide means. The buffer structure 112 is arranged on the end part side of vehicle, and the slide structure 113 is arranged between the buffer structure 112 and the wall 80. The upper-stage shock absorbing structure 100, the middle-stage shock absorbing structure 110, and the lower-stage shock absorbing structure 120 are fixedly held by the wall 80 and a support structure 111.

FIG. 2 shows an example in which the end part of vehicle has a flat surface. By taking this example, the operation in the case where a large obstacle collides with the shock absorbing structure is explained. When the large obstacle collides with the end part of vehicle, a collision load is transmitted to the upper-stage shock absorbing structure 100, the buffer structure 112, and the lower-stage shock absorbing structure 120 via the support structure 111. As a result, the upper-stage shock absorbing structure 100 and the lower-stage shock absorbing structure 120 crush in the travel direction to absorb collision energy. The buffer structure 112 substantially maintains its shape without being crushed, thereby transmitting the load between the upper-stage shock absorbing structure 100, the slide structure 113, and the lower-stage shock absorbing structure 120, and prevents the upper and lower-stage shock absorbing structures from falling to carry out control so that these shock absorbing structures crush in the travel direction. Also, if a predetermined load is applied to the slide structure 113, a slide mechanism operates so as to guide the buffer structure 112 to the rear. The operation of the slide mechanism can be controlled by a switch mechanism utilizing the breakage of a bolt or member.

Thus, the buffer structure 112 merely retreats without being crushed, so that it does not get involved in the crush load on the shock absorbing structure. Also, since the buffer structure 112 retreats along with the crush of the upper and lower-stage shock absorbing structures, energy can be absorbed until the upper and lower-stage shock absorbing structures crush completely. Thereby, the collision energy can be absorbed stably by the upper and lower-stage shock absorbing structures only under all collision conditions.

FIG. 3 is a side view of the shock absorbing structure, the view being used to explain the state in which the energy absorbing blocks of the upper-stage shock absorbing structure 100 and the lower-stage shock absorbing structure 120 are crushed completely by the collision in the example shown in FIG. 2.

FIG. 3 shows that the upper-stage shock absorbing structure 100 and the lower-stage shock absorbing structure 120 are deformed continuously in a bellows form and are in a completely crushed state, and the middle-stage shock absorbing structure 110 is in a state in which the slide structure 113 operates and the buffer structure 112 retreats to the rearmost position. Referring to this state, the shape, size, and arrangement of the buffer structure 112 is determined so that the crush wrinkles of the upper and lower-stage shock absorbing structures do not interfere with the buffer structure 112 and the slide mechanism operates until a bottomed state is established. Specifically, for example, the crush wrinkles of the upper-stage shock absorbing structure 100 become in a state of projecting by a width H to the outside from the position before crushing.

Therefore, the upper-stage shock absorbing structure 100 and the middle-stage shock absorbing structure 110 are arranged so as to provide a space having a width H or wider therebetween. Similarly, the lower-stage shock absorbing structure 120 and the middle-stage shock absorbing structure 110 are arranged so as to provide a necessary space therebetween based on the projection width of the crush wrinkles of the lower-stage shock absorbing structure 120. Also, it is necessary to make the length in the state in which the buffer structure 112 of the middle-stage shock absorbing structure 110 retreats to the rearmost position not longer than the length L in the state in which the upper-stage shock absorbing structure 100 and the lower-stage shock absorbing structure 120 crush completely. Therefore, the configuration is made such that the length of the buffer structure 112 is not longer than the length L.

Therefore, the middle-stage shock absorbing structure 110 does not interfere with the upper and lower-stage shock absorbing structures when the upper and lower-stage shock absorbing structures crush in the travel direction, and when the upper and lower-stage shock absorbing structures fall, the middle-stage shock absorbing structure 110 interferes with the upper and lower-stage shock absorbing structures and can carry out control so that the upper and lower-stage shock absorbing structures crush in the travel direction. As a result, the collision energy can be absorbed stably even under various collision conditions.

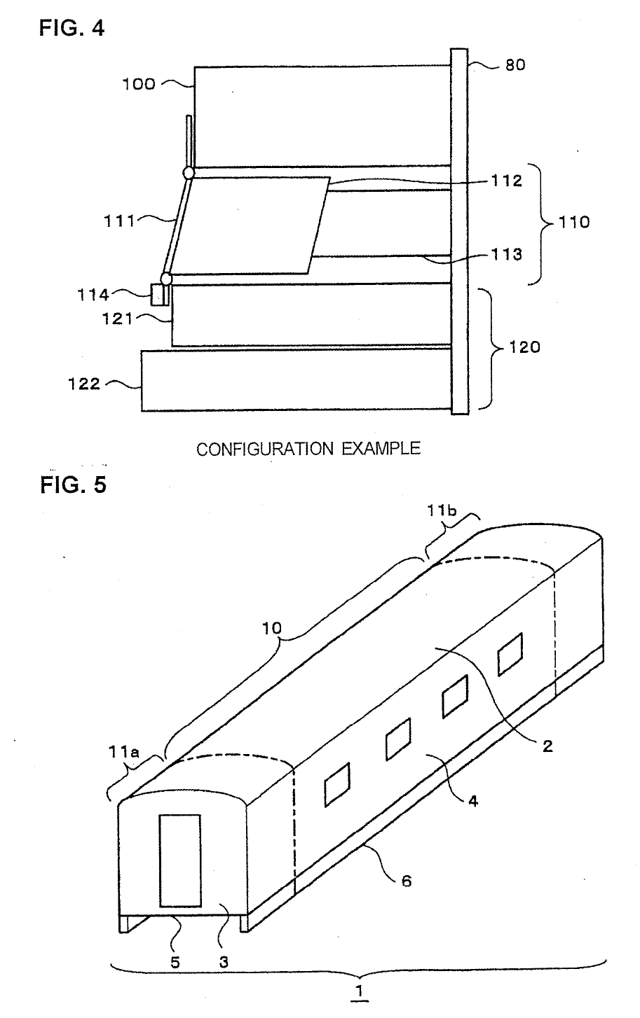

FIG. 4 is a side view of the shock absorbing structure on the vehicle having the shock absorbing structure of this example, the view being used to explain an overriding collision. FIG. 4 shows an example in which the end part of vehicle has a streamline shape, in which example, the lower-stage shock absorbing structure 120 is configured so as to project to the front beyond the upper-stage shock absorbing structure 100. In this example, the configuration is made such that the overriding collision can be overcome assuming the occurrence of a phenomenon that the obstacle first collides with the lower-stage shock absorbing structure 120 and subsequently sifts in the direction toward the upper-stage shock absorbing structure 100 along the shape of vehicle, thereby running onto the vehicle body.

In FIG. 4, the lower-stage shock absorbing structure 120 is formed by two kinds of energy absorbing blocks of an upper-stage energy absorbing block 121 and a lower-stage energy absorbing block 122. The lower-stage energy absorbing block 122 projects to the front most among the components of the shock absorbing structure, so that it collides with the obstacle first to absorb energy. The upper-stage energy absorbing block 121 is an energy absorbing block that operates against the run-on of the obstacle from the lower-stage energy absorbing block 122. In FIG. 4, the middle-stage shock absorbing structure 110 comprises the buffer structure 112 having a shape matching the streamline shape of vehicle and the slide structure 113. The upper-stage shock absorbing structure 100, the middle-stage shock absorbing structure 110, and the lower-stage shock absorbing structure 120 are fixedly held by the wall 80 and the support structure 111. The support structure 111 forms a plurality of surfaces so as to match the shapes of the shock absorbing structures. Also, the support structure 111 fixed to the upper-stage energy absorbing block 121 of the lower-stage shock absorbing structure 120 has a run-on preventing structure 114 extended outside the end of the upper-stage energy absorbing block 121 in the travel direction to provide a level difference.

In the construction described above, when an overriding collision occurs and the obstacle gets over the lower-stage energy absorbing block 122, the obstacle collides with the run-on preventing structure 114 and thereby the further rise thereof is hindered to stop the obstacle in the lower-stage shock absorbing structure 120. Thereby, the collision energy can be absorbed efficiently by the upper-stage energy absorbing block 121. The buffer structure 112 carries out control so that the upper-stage energy absorbing block 121 is prevented from falling and crushes in the travel direction. In the case where unbalance is present, for example, the upper-stage shock absorbing structure 100 and the lower-stage shock absorbing structure 120 have a different length as in this example, the configuration is made such that the collision angle of obstacle is adjusted, and the buffer structure 112 is crushed to efficiently absorb the collision energy. In FIG. 4, when the predetermined load is applied, the part of the buffer structure 112 projecting from the upper-stage shock absorbing structure 100 crushes, and the shape thereof changes, by which the crush of the upper-stage shock absorbing structure 100 and the lower-stage shock absorbing structure 120 is controlled. Also, when the predetermined load is applied, the support structure 111 separates from the upper-stage energy absorbing block 121, by which the upper-stage energy absorbing block 121 is not prevented from crushing. As the separating method, the switch mechanism utilizing the breakage of a bolt or member can be used.

Thereby, even if an overriding collision occurs, the obstacle can be stopped in the lower-stage shock absorbing structure 120, so that the collision energy can be absorbed by the lower-stage shock absorbing structure 120 that has the highest energy absorption efficiency.

As the material for forming the shock absorbing structure of this example, to absorb energy at the time of collision, any material that crushes in a bellows form in the travel direction when the predetermined load is applied may be used. Therefore, a hollow extruded shape made of a light alloy (for example, an aluminum alloy) or other energy absorbing blocks, which have conventionally been used for the shock absorbing structure, are used. Also, the upper, middle, and lower-stage shock absorbing structures may be formed by materials having different properties.

What is claimed is:

1. A vehicle in which a shock absorbing structure is arranged in an end part of the vehicle, the shock absorbing structure comprising:
an upper-stage shock absorbing means which is arranged in an upper part of a crushable zone to absorb collision energy by being crushed by a predetermined load;
a lower-stage shock absorbing means which is arranged in a lower part of the crushable zone to absorb the collision energy by being crushed by the predetermined load; and
a middle-stage shock absorbing means which is held between the upper-stage shock absorbing means and the lower-stage shock absorbing means arranged over and under the middle-stage shock absorbing means, wherein
the middle-stage shock absorbing means includes a buffer means and a slide means, and the buffer means is slid to the rear by the predetermined load.

2. The vehicle according to claim 1, wherein
the middle-stage shock absorbing means has a run-on preventing means extended in the travel direction outside the end of the lower-stage shock absorbing means to provide a level difference in a boundary part between the middle-stage shock absorbing means and the lower-stage shock absorbing means.

3. The vehicle according to claim 1, wherein
the middle-stage shock absorbing means is configured so that spaces wider than crush wrinkles of the upper and lower-stage shock absorbing means are secured between the middle-stage shock absorbing means and the upper-stage shock absorbing means and between the middle-stage shock absorbing means and the lower-stage shock absorbing means, and the buffer means having a length not longer than the crush remaining amount of the upper and lower-stage shock absorbing means is provided.
